(19) United States
(12) Patent Application Publication
(10) Pub. No.: US 2015/0170321 A1
(43) Pub. Date: Jun. 18, 2015

(54) APPLICATION COMPUTING METHOD OF MOBILE TERMINAL, AND APPARATUS AND SYSTEM FOR SUPPORTING THE SAME

(71) Applicant: Electronics and Telecommunications Research Institute, Daejeon (KR)

(72) Inventor: Kyung Ah YANG, Daejeon (KR)

(73) Assignee: Electronics and Telecommunications Research Institute, Daejeon (KR)

(21) Appl. No.: 14/458,583

(22) Filed: Aug. 13, 2014

(30) Foreign Application Priority Data
Dec. 13, 2013 (KR) 10-2013-0155900

(51) Int. Cl. G06T 1/20; H04L 29/06

(52) U.S. Cl. CPC G06T 1/20; H04L 67/42

(57) ABSTRACT

The present invention relates to application computing of a mobile terminal, and provides application computing system and method and an apparatus for supporting the same, including: a server configured to compute the application according to an offloading computing application computing request of a mobile terminal, encode a graphic rendering command of the application to be applicable to the mobile terminal by using a predefined UI library, and then transmit the encoded graphic rendering command to the mobile terminal; and a mobile terminal configured to decode the encoded graphic rendering command received from the server, convert the graphic rendering command to be suitable for the mobile UI by using the prestored UI library, and output a screen according to the converted command processing.

### CROSS-REFERENCE TO RELATED APPLICATIONS

This application claims priority to and the benefit of Korean Patent Application No. 10-2013-0155900 filed in the Korean Intellectual Property Office on Dec. 13, 2013, the entire contents of which are incorporated herein by reference.

### TECHNICAL FIELD

The present invention relates to an application operation control of a mobile terminal, and more particularly, to an application computing method of a mobile terminal, and apparatus and system for supporting the same capable of processing graphic rendering in the mobile terminal, by providing a mobile UI library for offloading to develop only an UI of the application for a mobile.

### BACKGROUND ART

A use of mobile terminals has been rapidly increased. As the mobile terminal gradually has high performance and high specification as compared with an existing desktop-oriented initial stage, a work environment is gradually moving with the mobile terminal as the center. In the mobile environment, as a work amount is increased, the demand of mobile users for a complex program use such as large-capacity data processing has been increased. Existing methods below are included in order to operate a desktop-dedicated application requiring high-performance specification in a mobile device.

As a first method, there is a method of computing the desktop application in a server by using a terminal service technique and servicing only a result screen in the mobile device. In this case, various functions which have the desktop application and are rapid and strong may be used. However, when an application developed to be optimized in an input apparatus (a keyboard, a mouse, or the like) of the server operates by transmitting only the result screen to the mobile device by using the terminal service technique, it is inconvenient to the use of the application due to a unique user interface of the mobile device such as a small screen, a touch screen interface, and a screen keyboard. Due to such a user interface, since it is difficult to properly use various elements such as a menu, a toolbar, an input window, and shortcut keys which exist in the desktop application in the mobile device, there is a problem in that the usability of the application deteriorates.

As a second method, there is a method of porting the desktop application to be suitable for the mobile device. In this case, the user interface problem pointed out above is solved, but a function of the corresponding SW is not sufficiently used due to problems such as computing resources which are insufficient in the mobile device, that is, a CPU, a memory, a storage space, and the like as compared with the desktop, and particularly, in terms of a SW developer, there is an impractical problem such as a problem that it is very costly during porting development.

### SUMMARY OF THE INVENTION

The present invention has been made in an effort to provide a method for computing an application of a mobile terminal, and apparatus and system for supporting the same that can take charge of computing of the application in a server providing rapid and strong functions and process a graphic processing result in the mobile terminal, so as to use the application requiring high performance even on the mobile terminal.

An exemplary embodiment of the present invention provides an application computing system, including: a server configured to compute the application according to an offloading application computing request of a mobile terminal, encode a graphic rendering command of the application to be applicable to the mobile terminal by using a predefined UI library, and then transmit the encoded graphic rendering command to the mobile terminal; and a mobile terminal configured to decode the encoded graphic rendering command received from the server, convert the graphic rendering command to be suitable for the mobile UI by using the prestored UI library, and output a screen according to the converted command processing.

Another exemplary embodiment of the present invention provides a server for supporting application computing of a mobile terminal, including: a server communication module configure to receive an offloading application computing request of the mobile terminal; and a server controller configured to compute the application according to the computing request, encode a graphic rendering command of the application to be applicable to the mobile terminal by using a predefined UI library, and then control the encoded graphic rendering command to be transmitted to the mobile terminal.

The server may further include a server storing unit configured to store at least one offloading application.

The server controller may generate an offloading SW list for selecting the offloading application to control the generated offloading SW list to be transmitted to the mobile terminal.

The server controller may compute an offloading application according the offloading SW selection information transmitted by the mobile terminal.

The server controller may convert the input signal received from the mobile terminal into a form applicable to an operation of the offloading application and then controls the application performance based on the input signal.

The server controller may control a graphic rendering command, which is generated by the application performance based on the input signal, to be transmitted to the mobile terminal.

Yet another exemplary embodiment of the present invention provides a mobile terminal for supporting application computing, including: a terminal communication unit configured to transmit a computing request of an offloading application to a server and receive a graphic rendering command encoded by driving of the offloading application computed in the server; a terminal controller configured to decode the received command and convert and process the graphic rendering command to be suitable for a mobile UI by using a prestored UI library; and a display unit configured to output a screen according to the processed graphic rendering command.

The display unit may output a list of a plurality of offloading applications.

The mobile terminal may further include an input unit configured to generate selection information selecting any one of the plurality of offloading applications.

The mobile terminal may further include an input unit configured to generate an input signal based on a user operation during a service provision according to the offloading application computing, in which the terminal communication unit may transmit the input signal to the server.

The terminal controller may receive a graphic rendering command from the server based on the input signal processing and controls screen updating of the display unit.

Still another exemplary embodiment of the present invention provides an application computing method, including: receiving an offloading application computing request of a mobile terminal, by a server; encoding a graphic rendering command according to the application computing to be applicable to the mobile terminal by using a predefined UI library, by the server; and transmitting the encoded graphic rendering command to the mobile terminal.

The method may further include: receiving the encoded graphic rendering command from the server, by the mobile terminal; decoding the encoded graphic rendering command, by the mobile terminal; converting the graphic rendering command to be suitable for the mobile UI by using the prestored UI library, by the mobile terminal; and outputting a screen according to the converted command processing, by the mobile terminal.

The method may further include: transmitting an offloading SW list for selecting the offloading application to the mobile terminal, by the server; receiving selection information selecting a specific offloading application of the list from the mobile terminal; and computing the offloading application according to the offloading SW selection information received from the mobile terminal, by the server.

The method may further include: transmitting an input signal inputted during the service provision according to the offloading application computing to the server, by the mobile terminal; converting the input signal into a form applicable to the offloading application to apply the converted input signal to the offloading application, by the server; receiving a graphic rendering command based on the input signal processing from the server, by the mobile terminal; and performing screen updating according to applying of the received graphic rendering command, by the mobile terminal.

As described above, according to a method for computing an application of a mobile terminal, and apparatus and system for supporting the same, the present invention can support applications using strong performance of a server to be utilized while reducing a load of a terminal in the mobile terminal.

The present invention supports an app to be independently developed from a mobile SW platform by providing a development environment that provides an offloading SW UI library.

### BRIEF DESCRIPTION OF THE DRAWINGS

FIG. 1 is a diagram schematically illustrating a system for computing an application of a mobile terminal according to an exemplary embodiment of the present invention.

FIG. 2 is a diagram for describing an overall system configuration corresponding to an offloading application development environment according to the exemplary embodiment of the present invention.

FIG. 3 is a diagram illustrating a development environment using an offloading SW UI library of the present invention in more detail.

FIG. 4 is a diagram for describing application command processing in an offloading engine according to the exemplary embodiment of the present invention.

FIG. 5 exemplarily illustrates a method of using an offloading SW in a mobile terminal 100 according to an exemplary embodiment of the present invention.

FIG. 6 is a diagram illustrating a configuration of a server for supporting an offloading SW service according to the exemplary embodiment of the present invention in more detail.

FIG. 7 is a diagram illustrating a configuration of a mobile terminal for supporting the offloading SW service according to the exemplary embodiment of the present invention in more detail.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In this cae, in the accompanying drawings, it should be noted that like reference numerals refer to like elements. The detailed description of known functions and constitutions which may obscure the gist of the present invention will be omitted. That is, it should be noted that in the following description, only a part required to appreciate an operation according to exemplary embodiment of the present invention will be described and the description of other parts will be omitted so as not to obscure the gist of the present invention.

In a method of computing an application of a mobile terminal, and apparatus and system for supporting the same of the present invention described below, a mobile offloading application service, as a technique of providing a desktop-dedicated application to a server as a service, is configured by a server providing a service by computing the application and a mobile terminal using the service.

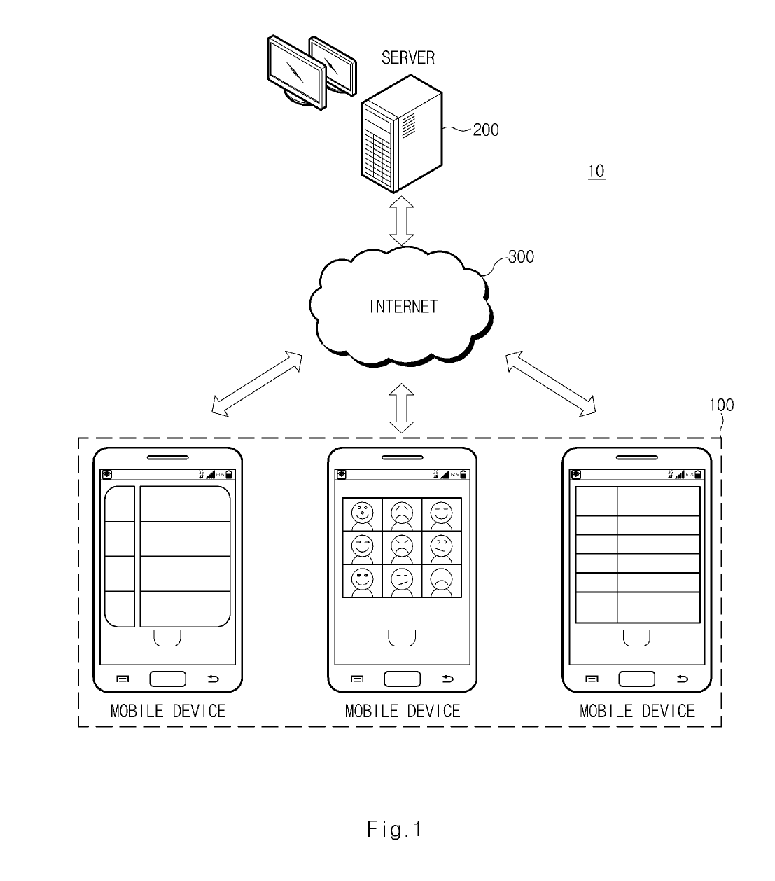

FIG. 1 is a diagram schematically illustrating a system for computing an application of a mobile terminal according to an exemplary embodiment of the present invention.

Referring to FIG. 1, an application computing system 10 of the present invention may include at least one mobile terminal 100, a communication network 300, and a server 200.

The application computing system 10 having the above configuration may perform direct rendering in the mobile terminal 100 by using a graphic processing resource of the mobile terminal 100 without using a display device of the server 200 when computing the application in the server 200. To this end, an essential UI portion of the desktop-dedicated application may be additionally developed for a mobile terminal.

When the application usable in the mobile terminal 100 is requested to the server 200, the server 200 computes the corresponding application and transmits only a command regarding graphic rendering to the mobile terminal 100. The mobile terminal 100 renders a result screen of the application on a screen of the mobile terminal 100 by internally computing the transmitted command. To this end, the application computing system of the present invention provides the following configurations.

First, in order to minimize efforts and costs to port a user interface portion of desktop software (SW), the application computing system provides an UI library for the development of the offloading SW. A developer develops an offloading application UI by using the UI library for the development of the mobile offloading SW development environment. In addition, the offloading SW UI library supports a range that can control sensing or a motion signal of a graphic resource and hardware of the mobile terminal 100.

Second, the application computing system 10 provides developing and debugging tools for the offloading application of the mobile terminal 100. The developer may develop the offloading SW UI by using the UI library in the mobile offloading SW development environment. The constructed application may perform compiling/debugging on the PC, and may reproduce various user interfaces on the PC through an emulator in a mobile terminal environment.

Third, the application computing system 10 provides an offloading engine for a server. The offloading engine performs a function that the server 200 transmits application rendering related UI functions to the mobile terminal 100 through the communication network 300, when the a request for the offloading application service occurs. That is, the server 200 side virtually computes a graphic related function such that a normal application is performed, and encodes a rendering command and rendering data so that substantial graphic rendering may be accurately performed in the mobile terminal 100 to transmit the encoded rendering command and data to the mobile terminal 100 through the communication network 300. Herein, the communication network 300 may be configured by, for example, a communication network such as an Internet. However, the present invention is not limited to a kind of the aforementioned communication network 300. The communication network 300 may be implemented by various networks that can transmit and receive data between the mobile terminal 100 and the server 200, for example, a mobile communication network, a communication network implemented by at least one of various generational communication modes.

Fourth, the application computing system 10 provides an offloading agent for a client of the mobile terminal 100. The offloading agent for the client of the mobile terminal 100 receives graphic information including the rendering command and the rendering data encoded from the server 200. The graphic information is encoded to a format suitable for rendering in the mobile terminal 100. The rendering command made by the offloading library is converted into a dependent device API or a native API and computed in the mobile terminal 100, and the result screen is displayed on the screen of the mobile terminal 100.

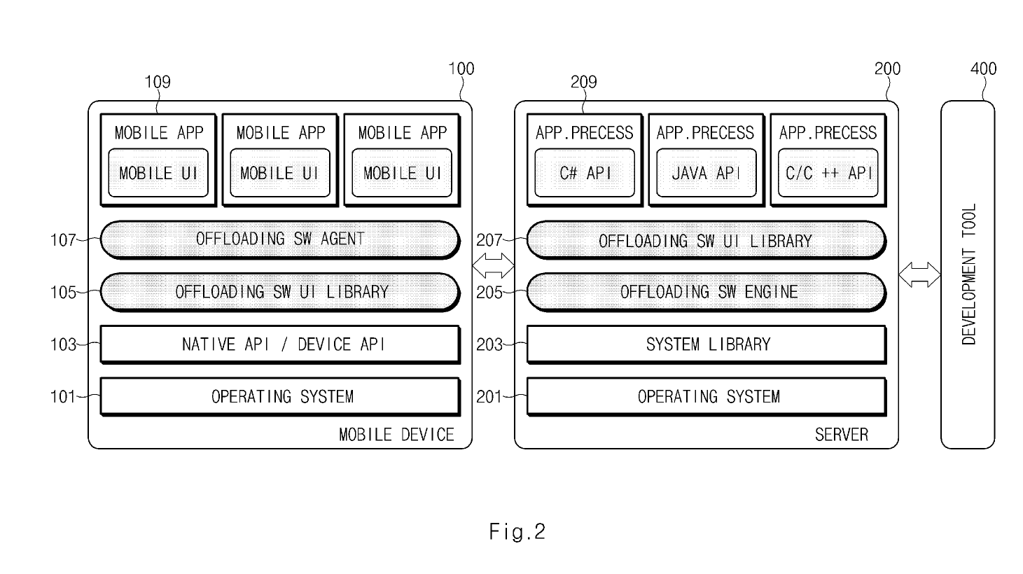

FIG. 2 is a diagram for describing an overall system configuration corresponding to a division-execution application development environment according to the exemplary embodiment of the present invention.

Referring to FIG. 2, the offloading application development system may include a development tool 400, a server environment 200a, and a mobile terminal environment 100a.

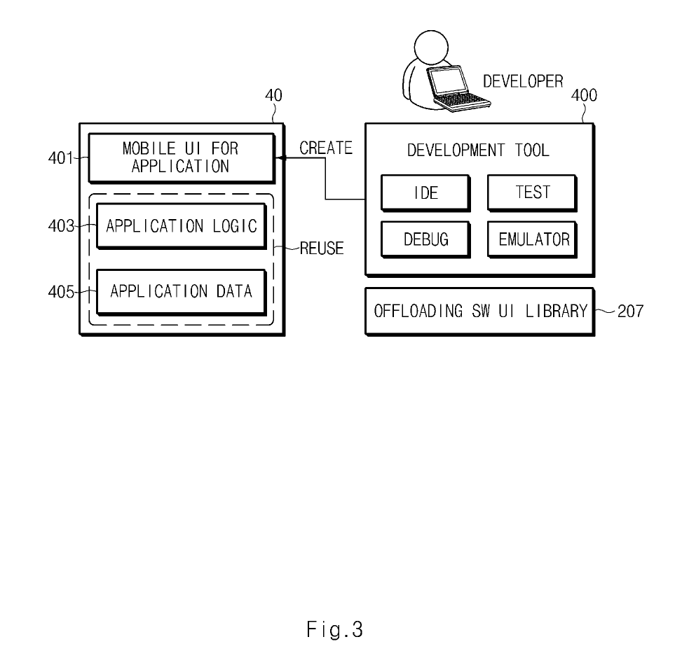

The development tool 400 may develop a desktop application which can output graphic information in the mobile terminal 100 by using program routines loaded in the server environment 200a. To this end, the development tool 400 includes a port for communicating with the server environment 200a, and an input unit for inputting a signal in a development process. A more detailed configuration of the development tool 400 will be described below with reference to FIG. 3.

The server environment 200a is driven in the server 200 according to a control of the development tool 400, and may support the development of the desktop application from the graphic information is output in the mobile terminal environment 100a. To this end, the server environment 200a may include an app processor 209, a server offloading SW UI library 207, a server offloading engine 205, a system library 203, and a server OS 201. The server OS 201 is an operating system for driving the server 200. The system library 203 supports program driving in the server environment 200a based on the server OS 201. Particularly, the system library 203 provides information required for driving the server offloading engine 205. The server offloading engine 205 is driven based on the server offloading SW UI library 207. The server offloading engine 205 extracts the graphic information in the driving of the application driven by the desktop application, for example, the app processor 209 to deliver the extracted graphic information to the mobile terminal environment 100a. The server offloading SW UI library 207 provides information required for driving the desktop application by the app processor 209. Particularly, the server offloading SW UI library 207 may provide information required for encoding the graphic information to be applied to the mobile terminal 100. The app processor 209 may be a processor that performs the driving of the desktop application driven in the server environment 200a. The app processor 209 performs the driving for the desktop application, and may deliver the graphic information, for example, the graphic rendering command to the server offloading SW UI library 207 according to the driving. Meanwhile, the app processor 209 may support processing of the input signal provide from the mobile terminal 100.

The mobile terminal environment 100a may include a mobile app 109, a client offloading agent 107, a terminal offloading SW UI library 105, a Native API/Device API 103, and a terminal OS 101. The terminal OS 101 is an operating system driven in the mobile terminal environment 100a, and the Native API/Device API 103 is a configuration of processing data required for program driving based on the terminal OS 101. The terminal offloading SW UI library 105 supports conversion or processing of the data for graphic information processing in the mobile terminal environment 100a. The client offloading agent 107 supports the driving of the mobile app 109. The mobile app 109 may be an app that receives and outputs the graphic information generated during the desktop application driving processing. Such a mobile app 109 may be configured by routines which process functions such as outputting of the graphic information and collecting and delivering of the input signal by actually driving the application in the server 200.

In relation to the offloading SW UI library for mobile graphic offloading of the present invention, the mobile graphic offloading service is a structure in which software logic and data of the desktop application are reused and a mobile UI instead of an existing desktop UI is newly developed and used. The present invention may provide the offloading SW UI libraries 105 and 207 which are interfaces for calling a function between different layers such as a business logic layer and a mobile UI layer.

The server 200 uses the system source of the server 200 and a subordinate API to the server OS 201 for computing the application except for the UI rendering. On the other hand, since the rendering is performed in the mobile terminal 100, not a computable command in the server 200 but a computable command in the mobile terminal 100 needs to be called. To this end, the mobile offloading SW service of the present invention provides the offloading SW UI libraries 105 and 207 for interfacing a different API between business logic and a UI of the application.

The server offloading SW UI library 207 serves as an interface which may call the subordinate API in a mobile terminal platform in an application implemented by a native programming language such as C/C++ and Java. The terminal offloading SW UI library 105 may expand and support the API in a range that can control sensing or a motion signal of a graphic resource and hardware of the mobile terminal 100. The developer develops the offloading application UI by using the offloading SW UI libraries 105 and 207.

Meanwhile, the application computing system 10 of the present invention supports development and debugging environment for developing the mobile application computing SW service.

FIG. 3 is a diagram illustrating a development environment using an offloading SW UI library of the present invention in more detail.

Referring to FIG. 3, the development environment may include a development tool 400 and an application 40 generated by the development tool 400.

The development tool 400 may include an editor IDE, a test and debug module, and an emulator. The editor IDE allows the developer to develop the mobile UI of the existing application by the offloading SW UI library 207 so as to minimize efforts and costs. As illustrated in FIG. 3, the developer separately develops only a user interface layer of an existing application by using a development environment supporting the offloading SW UI library 207. Since the offloading SW UI library 207 serves to interface the application logic 403 and the mobile UI 401, the offloading SW UI library 207 may reuse exiting business application logic 403 layer and application data 405 layer included in the application 40.

In order to integrally compute the offloading application, an emulator serving as a virtual machine function of the mobile terminal is provided. The emulator provides an environment to reproduce an actual UI of the mobile terminal SW on the PC.

Referring back to FIG. 2, the server offloading engine 205 serves to compute and finish the offloading SW. When the SW computing is requested from the mobile terminal 100 to the server 200, the server offloading engine 205 computes the corresponding application. The server 200 services the offloading application by a process unit of the application, and the application which has been computed according to a control of the server offloading engine 205 ends when the use of the corresponding application ends in the mobile terminal 100.

The server offloading engine 205 serves to call the system library of the server 200 side when the application of the server 200 side performs the business logic or the data layer command, and intercept and encode function calling information to transmit the encoded information to the mobile terminal 100, when the application calls the UI graphic library.

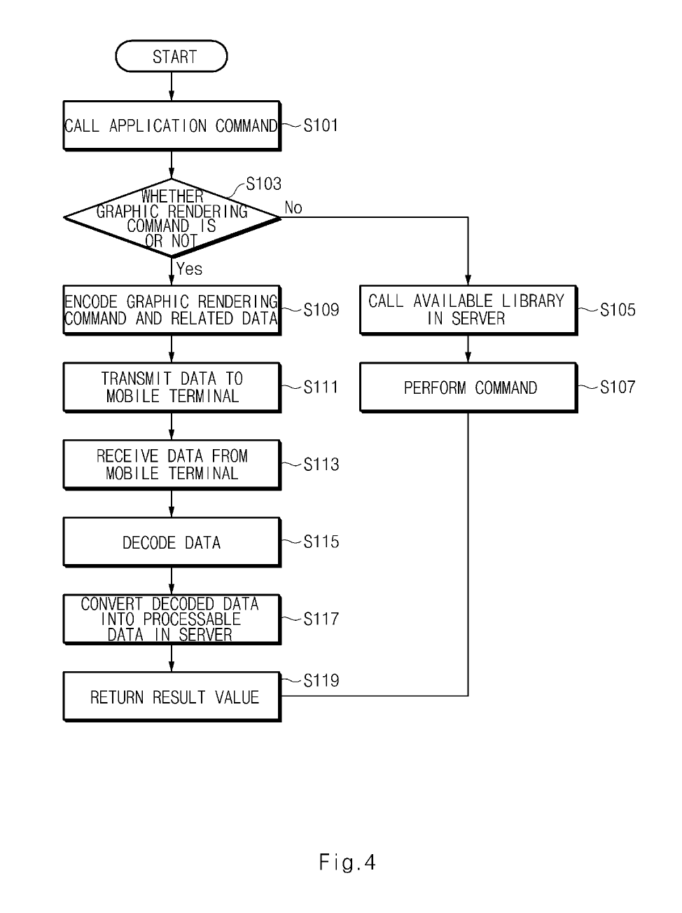

FIG. 4 is a diagram for describing application command processing in the offloading engine according to the exemplary embodiment of the present invention.

Referring to FIG. 4, as a command processing method in the offloading engine, first, in step S101, the server 200 serves to call a command of the computed application. In this case, the server offloading engine 205 determines whether the command computed in step S103 is a graphic rendering command. The server offloading engine 205 is branched to step S105 to call an available library in the server 200 when the computed command is not the graphic rendering command, and may support the corresponding command performance in step S107. For example, the server 200 performs the command by using an internal class library.

Meanwhile, in the case where the command performed in step S103 is the graphic rendering command, the server 200 is branched to step S109 to encode the corresponding command, and transmits the encoded command to the mobile terminal 100 in step S111. When the mobile terminal 100 receives the encoded graphic-related command from the server 200, the mobile terminal 100 may perform decoding of the corresponding data and the command processing. In this process, the server 200 encodes the graphic rendering command by using the offloading SW UI library 207 and then transmits the encoded graphic rendering command to the mobile terminal 100.

Meanwhile, as a user input signal is transmitted to the server 200 from the mobile terminal 100 performing the graphic rendering, in step S113, the server 200 may receive data corresponding to the user input from the mobile terminal 100. Then, the server offloading engine 205 may decode the data corresponding to the user input transmitted from the mobile terminal 100 in step S115, and convert the decoded data to processable data in the server 200 in step S117. In addition, the server 200 may perform result value returning in step S119. As a result, the application computed in the server 200 may perform signal processing as if the mobile terminal 100 directly receives the application from the user.

Referring back to FIG. 2, the client offloading agent 107 is a configuration installed to use the offloading SW service in the mobile terminal 100. The client offloading agent 107 provides a function of receiving and decoding graphic information transmitted from the server 200 that supports the offloading SW service. The decoded command is computed based on the library of the mobile terminal 100. Further, the client offloading agent 107 provides a function of transmitting user input information input through a user interface of the mobile terminal 100 to the server 200 supporting the offloading SW service.

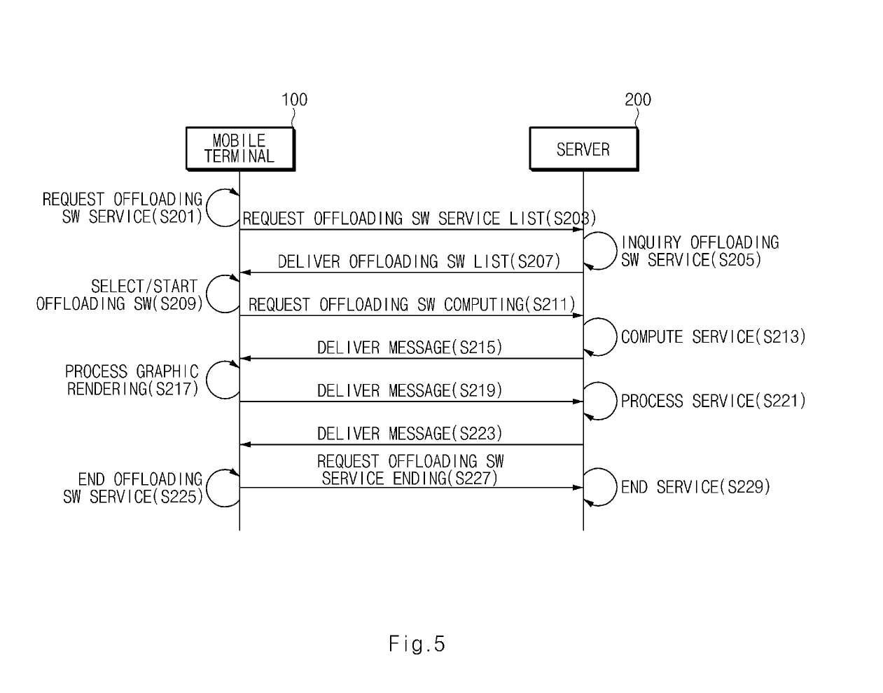

FIG. 5 exemplarily illustrates a method of using the offloading SW in the mobile terminal 100 according to the exemplary embodiment of the present invention.

Referring to FIG. 5, in step S201, when a request for using the offloading SW is inputted to the mobile terminal 100, the mobile terminal 100 requests a usable SW list to the server 200 side in step S203. To this end, the mobile terminal 100 may perform connection to the server 200 through the communication network 300. In addition, the mobile terminal 100 may output an icon or a menu item for using the offloading SW service.

When the server 200 receives a request of the offloading SW service list, the server 200 may inquiry the offloading SW service in step S205. That is, the server 200 may verify the offloading computable SW list in the mobile terminal 100. After the verification is completed, the server 200 configures the offloading computable SW list in step S207 to transmit the configured offloading computable SW list to the mobile terminal 100.

When the mobile terminal 100 receives the usable SW list from the server 200 to show the received SW list to the user, and a specific offloading SW is selected by the user input, the mobile terminal 100 performs an SW starting request selected in step S209. That is, the mobile terminal 100 may deliver the offloading SW service computing request selected by the user to the server 200 in step S211.

When the offloading SW computing request is received from the mobile terminal, the server 200 computes the offloading SW in step S213 and encodes graphic rendering command information of the successfully computed offloading SW. the server 200 transmits the encoded graphic rendering command information to the mobile terminal in step S215. The mobile terminal 100 decodes the command received in step S217 and performs the graphic rendering command by using the internal API to show the result screen to the user.

The client offloading agent 107 of the mobile terminal 100 receives an input signal of the user using the interface of the mobile terminal 100 in step S219 to transmit the received input signal to the server 200 side. The server 200 converts user input information transmitted in step S221 into an input signal suitable for the desktop application to process the converted input signal in an application process. The server 200 may encode the graphic command information in the result according to the input signal processing to transmit the command information to the mobile terminal 100 in step S223.

Meanwhile, the mobile terminal 100 may request offloading SW service ending to the server 200 in step S227, when an event of requesting the offloading SW service ending is collected in step S225. Then, the server 200 may end the offloading SW service corresponding to the corresponding request in step S229. In this process, the server 200 may finish the application and return a memory allocated for the application computing.

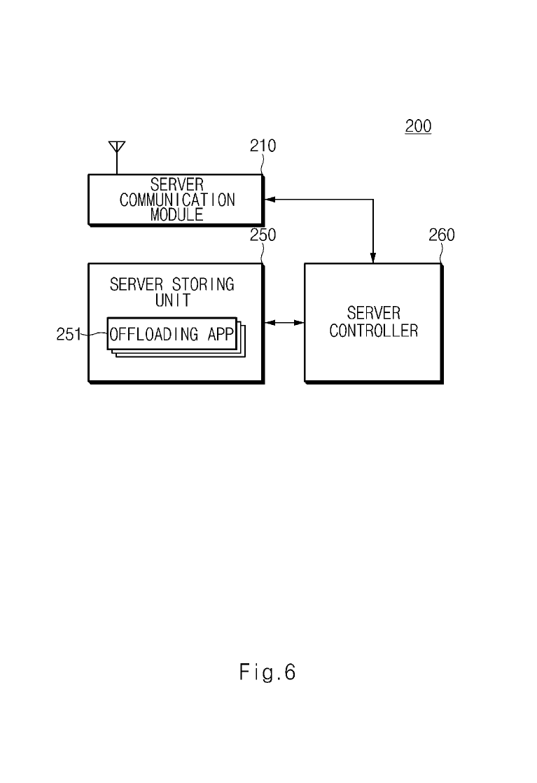

FIG. 6 is a diagram illustrating a configuration of a server for supporting the offloading SW service according to the exemplary embodiment of the present invention in more detail.

Referring to FIG. 6, the server 200 of the present invention may include a server communication module 210, a server storing unit 250, and a server controller 260.

The server communication module 210 performs a communication channel formation with the communication network 300, and performs a communication channel formation with the mobile terminal 100. The server communication module 210 may perform receiving of an offloading SW service requesting signal, receiving of a specific offloading SW selecting signal, and receiving of a user input signal from the mobile terminal 100. The signals received by the server communication module 210 are delivered to the server controller 260 to be used for supporting the offloading SW service of the present invention.

The server storing unit 250 may store various program information such as an operating system for driving the server controller 260 and information for program operation or according to the program operation. The server storing unit 250 may include at least one offloading app 251 corresponding to the offloading SW of the present invention. The offloading app 251 may be an app which is executed in the server 200 and transmits the graphic rendering command to the mobile terminal 100. Meanwhile, the server storing unit 250 may store the offloading SW UI library for supporting the offloading SW service, and provide the stored offloading SW UI library according to a call of the server controller 260.

The server controller 260 may perform signal processing and delivery for supporting the offloading SW service and data processing. In more detail, the server controller 260 may control the server communication module 210 to form the communication channel, when the connection of the mobile terminal 100 is requested. In addition, when the server controller 260 receives the offloading SW service request from the mobile terminal 100, the server controller 260 may prepare an offloading SW list based on the offloading app 251 stored in the server storing unit 250. In this case, the server controller 260 verifies hardware information of the mobile terminal 100 and the like to separately classify the offloading apps 251 in which the graphic rendering processing may be performed in the mobile terminal 100. Meanwhile, the server controller 260 may transmit the prepared offloading SW list to the mobile terminal 100 and receive specific offloading SW selection information from the mobile terminal 100. Then, the server controller 260 may drive the offloading SW corresponding to the selection information and encode the graphic rendering command to be transmitted to the mobile terminal 100 based on the offloading SW UI library. The server controller 260 may transmit the encoded command to the mobile terminal 100. In addition, the server controller 260 may receive the input signal delivered from the mobile terminal 100, and substitute the input signal with a command which is applicable to the offloading SW and then apply the substituted command to the offloading SW operation. In this process, in the case where the UI update is required, the server 200 may control encoding and transmitting of the graphic rendering command. In order to support the offloading SW service, the server controller 260 may drive the server offloading engine 205 described above.

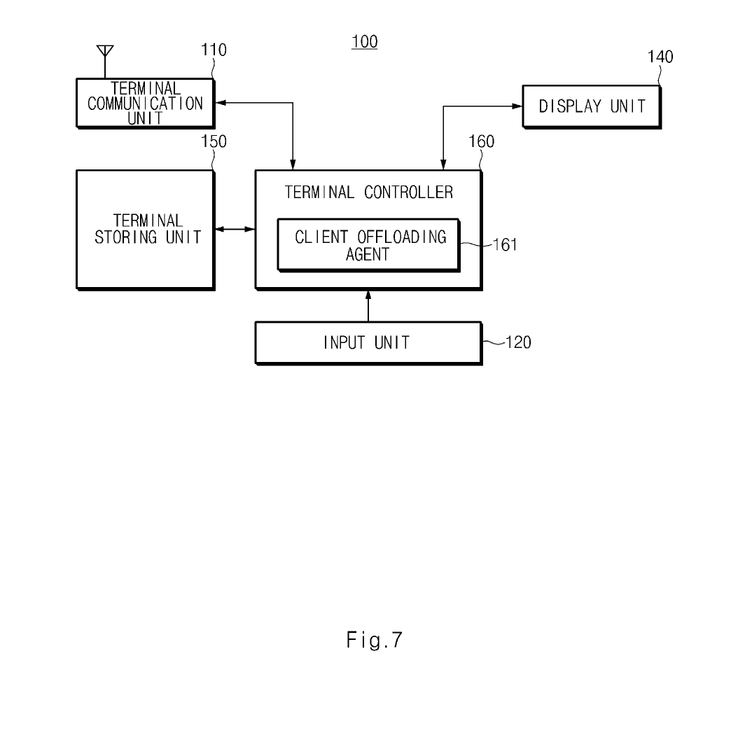

FIG. 7 is a diagram illustrating a configuration of the mobile terminal for supporting the offloading SW service according to the exemplary embodiment of the present invention in more detail.

Referring to FIG. 7, the mobile terminal 100 of the present invention may include a terminal communication unit 110, an input unit 120, a display unit 140, a terminal storing unit 150, and a terminal controller 160.

The terminal communication unit 110 may form a communication channel with the communication network 300 and form a communication channel with the server 200. The terminal communication unit 110 may transmit an offloading SW service requesting message to the server 200 and receive the offloading SW list from the server 200. In addition, the terminal communication unit 110 may transmit the specific offloading SW selection information to the server 200 and receive the graphic rendering command encoded according to the offloading SW driving from the server 200. In addition, the terminal communication unit 110 may transmit the input signal inputted by the input unit 120 to the server 200.

The input unit 120 may generate an input signal according to the user input for an operation control of the mobile terminal 100. The input unit 120 may include various physical keys such as a keypad, a key button, and a keyboard, a touch key, and the like. The input unit 120 may generate a specific input signal according to the user operation during the screen output by the graphic rendering command according to the offloading SW driving. Meanwhile, the input unit 120 may include at least one sensor, for example, a gyro sensor, an acceleration sensor, a pressure sensor, an image sensor, and the like. In addition, the input unit 120 may collect a gesture signal according to a user gesture and deliver the gesture signal to the terminal controller 160 as the input signal.

The display unit 140 may output various screens according to the operation of the mobile terminal 100. For example, the display unit 140 may output an idle screen, a menu screen, and the like of the mobile terminal 100, and output an icon or a menu item for activating the offloading SW service. The display unit 140 may be provided as a touch screen form, and in this case, the display unit 140 may operate as an input means. Meanwhile, the display unit 140 may output a screen according to connection with a server 200 predefined according to the offloading SW service activation request or a server 200 defined by the user input, an offloading SW list output screen, and a screen according to the graphic rendering command computing received according to the offloading SW driving. Further, the display unit 140 may receive the graphic rendering command according to the input signal processing to perform screen updating.

The terminal storing unit 150 may store an operating system requiring for the operation of the mobile terminal 100, an application for supporting a specific user function, and the like. The terminal storing unit 150 may temporarily store the encoded graphic rendering command received from the server 200. Further, the terminal storing unit 150 may temporarily or semi-permanently store at least a part of the screen according to the offloading SW driving output to a current display unit 140 according to the user operation. The terminal storing unit 150 may store the offloading SW UI library, and provide the stored offloading SW UI library according to a call of the terminal controller 160. The offloading SW UI library may be used in a mobile UI applying process of the graphic rendering command provided from the server 200. In the present invention, the offloading SW UI library may be used for supporting the mobile environment in the server, or used for applying the graphic information provided from the server to the mobile environment.

The terminal controller 160 may support data processing and signal processing of the mobile terminal 100 for supporting the offloading SW service. For example, the terminal controller 160 may perform the control of the terminal communication unit 110 to control the communication channel formation or the communication channel release. Further, the terminal controller 160 may control transmission of the offloading SW selection information selected according to the user input. Particularly, when the terminal controller 160 receives the encoded graphic rendering command from the server 200, the terminal controller 160 decodes the encoded graphic rendering command and performs the corresponding command processing. To this end, the terminal controller 160 may include a client offloading agent 161.

The client offloading agent 161 decodes the encoded graphic rendering command by using the pre-stored offloading SW UI library and converts the corresponding graphic rendering command into a command for the mobile UI. In addition, the client offloading agent 161 may control a screen configuration according to the mobile UI command. Further, the client offloading agent 161 transmits the input signal inputted from the input unit 120 from the server 200 during the offloading SW service and receives the graphic rendering command among the result values based on the corresponding input signal processing to process the received graphic rendering command. As a result, the client offloading agent 161 performs the server 200 delivery of the user input signal and the graphic rendering command receiving according to the server 200 delivery, and thus the desktop application is driven in the server 200, but processed in the mobile terminal 100.

The aforementioned present invention provides a method of separating screen processing of the application and computing of the application between the mobile terminal 100 having limited resources and the server 200 exerting powerful performance. For example, in the case where a program performing intelligently processing requiring a complicated computing function is used in the mobile terminal 100 of the mobile environment, actual computing of the application is performed in the server 200, and only a user interface portion of the application is performed in the mobile terminal 100. The present invention may support the corresponding functions to be used as it is in the mobile environment like using the application in an existing desktop, by using an application service computed on the server 200 through the communication network 300 to be used in the mobile terminal 100.

It will be appreciated that various embodiments of the present invention have been described herein for purposes of illustration, and that various modifications, changes, substitutions may be made by those skilled in the art without departing from the essential characteristic of the present invention. Accordingly, the various exemplary embodiments disclosed herein are intended not to limit but to describe the technical spirit of the present invention and the true scope of the spirit of the present invention is not limited to the exemplary embodiments. The scope of the present invention should be interpreted by the appended claims and the technical spirits in the equivalent range thereto are analyzed to be embraced by the right scope of the present invention.

What is claimed is:

1. An application computing system, comprising:
a server configured to compute the application according to an offloading application computing request of a mobile terminal, encode a graphic rendering command of the application to be applicable to the mobile terminal by using a predefined UI library, and then transmit the encoded graphic rendering command to the mobile terminal; and
a mobile terminal configured to decode the encoded graphic rendering command received from the server, convert the graphic rendering command to be suitable for the mobile UI by using the prestored UI library, and output a screen according to the converted command processing.

2. A server for supporting application computing of a mobile terminal, comprising:
a server communication module configure to receive an offloading application computing request of the mobile terminal; and
a server controller configured to compute the application according to the computing request, encode a graphic rendering command of the application to be applicable to the mobile terminal by using a predefined UI library, and then control the encoded graphic rendering command to be transmitted to the mobile terminal.

3. The server of claim 2, further comprising:
a server storing unit configured to store at least one offloading application.

4. The server of claim 3, wherein the server controller generates an offloading SW list for selecting the offloading application to control the generated offloading SW list to be transmitted to the mobile terminal.

5. The server of claim 3, wherein the server controller computes an offloading application according the offloading SW selection information transmitted by the mobile terminal.

6. The server of claim 3, wherein the server controller converts an input signal received from the mobile terminal into a form applicable to an operation of the offloading application and then controls the application performance based on the input signal.

7. The server of claim 6, wherein the server controller controls a graphic rendering command, which is generated by the application performance based on the input signal, to be transmitted to the mobile terminal.

8. A mobile terminal for supporting application computing, comprising:
a terminal communication unit configured to transmit a computing request of an offloading application to a server and receive a graphic rendering command encoded by driving of the offloading application computed in the server;
a terminal controller configured to decode the received command and convert and process the graphic rendering command to be suitable for a mobile UI by using a prestored UI library; and
a display unit configured to output a screen according to the processed graphic rendering command.

9. The mobile terminal of claim 8, wherein the display unit outputs a list of a plurality of offloading applications.

10. The mobile terminal of claim 9, further comprising:
an input unit configured to generate selection information selecting any one of the plurality of offloading applications.

11. The mobile terminal of claim 8, further comprising:
an input unit configured to generate an input signal based on a user operation during a service provision according to the offloading application computing,
wherein the terminal communication unit transmits the input signal to the server.

12. The mobile terminal of claim 11, wherein the terminal controller receives a graphic rendering command based on the input signal processing from the server and controls screen updating of the display unit.

13. An application computing method, comprising:
receiving an offloading application computing request of a mobile terminal, by a server;
encoding a graphic rendering command according to the application computing to be applicable to the mobile terminal by using a predefined UI library, by the server; and
transmitting the encoded graphic rendering command to the mobile terminal.

14. The application computing method of claim 13, further comprising:
receiving the encoded graphic rendering command from the server, by the mobile terminal;
decoding the encoded graphic rendering command, by the mobile terminal;
converting the graphic rendering command to be suitable for the mobile UI by using the prestored UI library, by the mobile terminal; and
outputting a screen according to the converted command processing, by the mobile terminal.

15. The application computing method of claim 13, further comprising:
transmitting an offloading SW list for selecting the offloading application to the mobile terminal, by the server;
receiving selection information selecting a specific offloading application of the list from the mobile terminal; and
computing the offloading application according to the offloading SW selection information received from the mobile terminal, by the server.

16. The application computing method of claim 13, further comprising:
transmitting an input signal inputted during the service provision according to the offloading application computing to the server, by the mobile terminal;
converting the input signal into a form applicable to the offloading application to apply the converted input signal to the offloading application, by the server;
receiving a graphic rendering command based on the input signal processing from the server, by the mobile terminal; and
performing screen updating according to applying of the received graphic rendering command, by the mobile terminal.
